(19) United States
(12) Patent Application Publication
(10) Pub. No.: US 2026/0184021 A1
(43) Pub. Date: Jul. 2, 2026

(54) BLOCKCHAIN-DRIVEN AUTOMATED 3D PRINTING MODULAR CONSTRUCTION MANAGEMENT SYSTEM AND METHOD

(71) Applicant: UNIVERSITY OF SHARJAH, Sharjah (AE)

(72) Inventors: Mohamed Ait GACEM, Sharjah (AE); Saleh ABU DABOUS, Sharjah (AE)

(21) Appl. No.: 19/436,680

(22) Filed: Dec. 30, 2025

Related U.S. Application Data
(60) Provisional application No. 63/740,556, filed on Dec. 31, 2024.

(51) Int. Cl. B29C 64/393; B33Y 50/02; G16Y 40/10; G16Y 40/35; H04L 9/00

(52) U.S. Cl. CPC B29C 64/393; G16Y 40/10; G16Y 40/35; H04L 9/50; B33Y 50/02

(57) ABSTRACT

The present disclosure discloses a blockchain-driven automated 3D printing modular construction management system, comprising: a decentralized blockchain network deployed on node devices of one or more stakeholders, wherein the one or more stakeholders include one or more of a 3D printing assembly manufacturer, a quality inspection team, a regulatory body, a logistics provider, a consultant, a budget team, and an end-user/client/owner, wherein the decentralized blockchain network is configured to store immutable records of full-lifecycle data including design specifications, material procurement, 3D printing production, logistics transportation, on-site assembly, final handover, and post-construction maintenance; a 3D printing hardware module including at least one 3D printer integrated with blockchain nodes, wherein the 3D printing hardware module real-time records printing parameters, material usage, and quality inspection data to the decentralized blockchain network, and synchronizes digital files, production schedules, and quality control measures with the network; an IoT sensor module comprising a material parameter sensor, a production progress sensor, and a transportation tracking sensor, wherein the IoT sensor module transmits real-time data to the decentralized blockchain network after a computing preprocessing using optimized computational algorithms, and supports real-time verification of construction processes; and a smart contract module embedded in the decentralized blockchain network, wherein the smart contract module includes pre-defined terms for automated material authentication, supply chain transaction validation and milestone-based payment triggering, and links financial transactions directly to project milestones.

### FIELD

The present disclosure relates to the field of construction management systems, and more particularly to a blockchain-driven automated system and method for managing 3D printing modular construction projects, integrating blockchain technology, IoT sensors, and smart contracts to enhance transparency, efficiency, and sustainability across the full lifecycle of modular construction.

### BACKGROUND

The construction industry has traditionally relied on in-situ Reinforced Concrete (RC) methods

due to their cost-effectiveness and widespread availability. However, this approach has several significant drawbacks that impact both the environment and the efficiency of construction projects. Traditional RC construction generates substantial waste, with studies indicating that new in-situ RC projects can produce between 17.8 and 40.1 kg/m² of waste, contributing to environmental degradation and highlighting the need for more sustainable construction methods. Additionally, the high costs and extended time frames associated with RC construction, particularly related to formwork-which can constitute over 60% of the total project cost and up to 70% of the construction duration-further underscore the inefficiencies of this method. As the global population continues to urbanize, with projections that 68% of the world's population will reside in cities by 2050, there is a critical need for faster and more efficient construction methods.

Modular construction has emerged as a promising alternative to traditional construction methods, offering advantages such as reduced construction time, improved quality control, and lower costs by fabricating components off-site and assembling them on-site. This method minimizes material waste and optimizes resource use, making it a more sustainable option compared to traditional practices. Furthermore, advancements in technology, such as 3D Concrete Printing (3DCP), have the potential to further enhance the sustainability and efficiency of modular construction by reducing waste, lowering costs, and improving worker safety. However, challenges such as the unpredictability of concrete mixes and high material costs remain. Despite these advancements, further research is required to fully understand the efficiency of 3DCP compared to other construction techniques, particularly in terms of cost-effectiveness, construction duration, and sustainability impacts.

While modular and off-site construction (OSC) methods have shown promise, they still face challenges in achieving their full potential in time and cost savings. In some cases, the time from design to on-site assembly can exceed that of conventional methods, and issues related to low labor productivity due to the high skill levels required for on-site assembly have been reported. Additionally, many prefabrication projects achieve less than 5% savings in total labor hours, and the cost of prefabricated buildings can be significantly higher than conventional buildings. The slow adoption of digital technologies in construction further complicates the implementation of Industry 4.0 technologies, which have the potential to improve construction management practices.

While existing research highlights the transformative potential of blockchain technology in various aspects of the construction industry, there remains a significant gap in its application to 3D printing-based modular construction. Current studies predominantly focus on traditional construction methods and off-site construction techniques, but they do not address the specific challenges and opportunities presented by the integration of 3D printing technology in modular construction.

3D printing-based modular construction represents a unique set of requirements and processes that differ from those of conventional construction methods. This innovative approach involves the off-site fabrication of modular components using 3D printing technology, which allows for greater design flexibility, reduced waste, and improved sustainability. However, the complexity of managing the production, quality control, and logistics of 3D-printed components requires a tailored approach that current blockchain applications in construction have not yet explored. Furthermore, existing blockchain frameworks in construction have primarily focused on enhancing traditional supply chains and project management. They do not fully leverage the potential of blockchain to address the specific needs of 3D printing-based modular construction, such as real-time monitoring of 3D printing processes, quality assurance of printed components, and the integration of digital manufacturing data into the supply chain. This gap presents an opportunity to develop new blockchain-based frameworks that can optimize the entire lifecycle of 3D-printed modular construction, from design and material procurement to on-site assembly and post-construction management.

Hence, the current body of research has not sufficiently addressed the integration of blockchain technology with 3D printing-based modular construction. This gap underscores the necessity for further exploration and development of blockchain frameworks specifically designed to support and enhance the innovative practices of 3D printing in modular construction, ensuring improved efficiency, transparency, and sustainability in this emerging field.

The proposed framework integrates blockchain technology and 3D printing into modular construction, enhancing transparency, efficiency, and sustainability across all phases of construction, from design to post-construction. By automating the construction process and managing all interactions through a blockchain framework, the invention improves supply chain management and traceability, ensures the authenticity and quality of 3D-printed components, and enhances compliance with industry standards. This framework also mitigates counterfeiting, strengthens intellectual property protection, and supports direct peer-to-peer transactions, reducing costs and eliminating intermediaries. By addressing these challenges, the proposed invention provides a transformative solution that makes modular construction more resilient, cost-effective, and environmentally friendly, filling the gaps left by existing technologies and practices.

### SUMMARY

The invention presents a groundbreaking blockchain-based framework designed to revolutionize

the management of 3D printing modular construction projects. By integrating advanced blockchain technology with state-of-the-art 3D printing techniques and modular construction methods, this framework offers a secure, transparent, and efficient construction management system that addresses many of the current challenges in the construction industry.

This innovative solution enhances transparency by using blockchain to create an immutable ledger that records all transactions, data exchanges, and construction processes. It allows stakeholders, from manufacturers to end-users, to access real-time information, fostering trust and collaboration throughout the project lifecycle. Additionally, the use of smart contracts automates financial transactions, ensuring timely payments and reducing administrative overhead. The integration of 3D printing technology within this framework enables the precise fabrication of modular components, significantly reducing material waste and promoting sustainability. The system also enhances supply chain management by providing accurate tracking and traceability of materials and components from procurement to final assembly. By optimizing construction processes and ensuring compliance with industry standards, this blockchain-based framework paves the way for more efficient, sustainable, and cost-effective construction practices. It is an ideal solution for construction companies, 3D printing service providers, real estate developers, and other stakeholders looking to innovate and lead in the modern construction landscape. With its focus on improving project outcomes through advanced technology integration, this invention represents a significant advancement in the field of modular construction, setting new standards for transparency, efficiency, and sustainability in the industry.

There is provided, according to a first aspect of the present disclosure, a blockchain-driven automated 3D printing modular construction management system, comprising: a decentralized blockchain network deployed on node devices of one or more stakeholders, wherein the one or more stakeholders include one or more of a 3D printing assembly manufacturer, a quality inspection team, a regulatory body, a logistics provider, a consultant, a budget team, and an end-user/client/owner, wherein the decentralized blockchain network is configured to store immutable records of full-lifecycle data including design specifications, material procurement, 3D printing production, logistics transportation, on-site assembly, final handover, and post-construction maintenance; a 3D printing hardware module including at least one 3D printer integrated with blockchain nodes, wherein the 3D printing hardware module real-time records printing parameters, material usage, and quality inspection data to the decentralized blockchain network, and synchronizes digital files, production schedules, and quality control measures with the network; an IoT sensor module comprising a material parameter sensor, a production progress sensor, and a transportation tracking sensor, wherein the IoT sensor module transmits real-time data to the decentralized blockchain network after a computing preprocessing using optimized computational algorithms, and supports real-time verification of construction processes; and a smart contract module embedded in the decentralized blockchain network, wherein the smart contract module includes pre-defined terms for automated material authentication, supply chain transaction validation and milestone-based payment triggering, and links financial transactions directly to project milestones.

Advantageously, the inventors have found that the integration of blockchain technology in the 3D printing modular construction framework ensures that all transactions, design changes, and construction processes are recorded in a decentralized, immutable ledger. This transparency provides all stakeholders, including manufacturers, suppliers, construction companies, architects, engineers, project managers, and clients, with real-time access to accurate and reliable data. As a result, trust among parties is significantly enhanced, reducing the likelihood of disputes and fostering better collaboration throughout the construction lifecycle.

According to embodiments of the present disclosure, the decentralized blockchain network is a private blockchain network and implements stakeholder-specific read/write access rights based on their roles in the construction lifecycle, enabling transparent real-time data access for all authorized entities. Advantageously, this may provide enhanced data security and privacy by restricting access to sensitive project information based on stakeholder roles, while still maintaining transparency among authorized parties.

According to embodiments of the present disclosure, the 3D printer in the 3D printing hardware module is a high-precision 3D printer equipped with sensors to monitor material quality and integrity. Advantageously, this may enable the precise fabrication of modular components with complex geometries, reducing material waste and ensuring high-quality outputs that meet project specifications.

According to embodiments of the present disclosure, the optimized computational algorithms of the IoT sensor module are configured to minimize blockchain latency. Advantageously, this may ensure that data and transaction records are updated almost instantaneously, maintaining the pace of construction activities and enabling real-time decision-making.

According to embodiments of the present disclosure, the optimized computational algorithms of the IoT sensor module are configured to maximize blockchain throughput. Advantageously, this may enable the blockchain to handle a large number of transactions in a short period, which is particularly beneficial during peak phases of construction when numerous transactions are occurring simultaneously.

According to embodiments of the present disclosure, the 3D printing hardware module's sensors monitor the quality and integrity of materials used in 3D printing. Advantageously, this may ensure compliance with project specifications and industry standards, reducing the risk of defects and enhancing overall construction quality.

According to embodiments of the present disclosure, the smart contract module's milestone-based payment triggering is verified through blockchain-enabled sensors and IoT devices. Advantageously, this may automate financial transactions and ensure timely payments upon verified completion of project milestones, reducing administrative overhead and minimizing payment disputes.

According to embodiments of the present disclosure, the immutable records stored by the decentralized blockchain network include design changes of the modular construction. Advantageously, this may provide a comprehensive audit trail of all design modifications, facilitating smoother approval processes and reducing the likelihood of disputes related to design changes.

According to embodiments of the present disclosure, the decentralized blockchain network supports blockchain-based intellectual property protection of 3D printing modular construction designs. Advantageously, this may safeguard proprietary designs from unauthorized access and counterfeiting, strengthening intellectual property rights for designers and manufacturers.

There is provided, according to a second aspect of the present disclosure, a blockchain-driven automated 3D printing modular construction management method, comprising the steps of: deploying a decentralized blockchain network on node devices of one or more stakeholders, wherein the one or more stakeholders include one or more of a 3D printing assembly manufacturer, a quality inspection team, a regulatory body, a logistics provider, a consultant, a budget team, and an end-user/client/owner; configuring the decentralized blockchain network to store immutable records of full-lifecycle data including design specifications, material procurement, 3D printing production, logistics transportation, on-site assembly, final handover, and post-construction maintenance; integrating at least one 3D printer with blockchain nodes to form a 3D printing hardware module, wherein the 3D printing hardware module real-time records printing parameters, material usage, and quality inspection data to the decentralized blockchain network, and synchronizes digital files, production schedules, and quality control measures with the network; providing an IoT sensor module comprising a material parameter sensor, a production progress sensor, and a transportation tracking sensor, wherein the IoT sensor module performs computing preprocessing on real-time collected data using optimized computational algorithms and transmits the processed data to the decentralized blockchain network to support real-time verification of construction processes; and embedding a smart contract module in the decentralized blockchain network, wherein the smart contract module executes pre-defined terms for automated material authentication, supply chain transaction validation and milestone-based payment triggering, and links financial transactions directly to project milestones.

According to embodiments of the present disclosure, the decentralized blockchain network is a private blockchain network, and the method further comprises implementing stakeholder-specific read/write access rights based on the stakeholders'roles in the construction lifecycle to enable transparent real-time data access for all authorized entities.

According to embodiments of the present disclosure, the 3D printer in the 3D printing hardware module is a high-precision 3D printer equipped with sensors to monitor material quality and integrity, and the method comprises using the high-precision 3D printer to fabricate modular components while recording printing-related data to the decentralized blockchain network.

According to embodiments of the present disclosure, the optimized computational algorithms of the IoT sensor module are configured to minimize blockchain latency, and the method comprises processing the real-time collected data via the algorithms to reduce the time taken to add data blocks to the blockchain.

According to embodiments of the present disclosure, the optimized computational algorithms of the IoT sensor module are configured to maximize blockchain throughput, and the method comprises processing the real-time collected data via the algorithms to increase the number of transactions processed per second by the blockchain.

According to embodiments of the present disclosure, the method further comprises using sensors of the 3D printing hardware module to monitor the quality and integrity of materials used in 3D printing, and recording the monitored data to the decentralized blockchain network for compliance verification.

According to embodiments of the present disclosure, the milestone-based payment triggering of the smart contract module is verified through blockchain-enabled sensors and IoT devices, and the method comprises using the sensors and devices to confirm the completion of project milestones and triggering corresponding payments via the smart contract module.

According to embodiments of the present disclosure, the method further comprises recording design changes of the modular construction in the immutable records stored by the decentralized blockchain network.

According to embodiments of the present disclosure, the method further comprises utilizing the decentralized blockchain network to implement blockchain-based intellectual property protection of 3D printing modular construction designs by storing design-related immutable records and controlling access to the designs via stakeholder-specific rights.

It will be appreciated that features disclosed in relation to one aspect of the present disclosure may be applicable to other aspects of the present disclosure, and vice versa.

### BRIEF DESCRIPTION OF THE DRAWINGS

The manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of the present disclosure and are therefore not to be considered limiting of its scope, for the present disclosure may admit to other equally effective embodiments.

FIG. 1 shows a technical structure diagram of the blockchain-driven automated 3D printing modular construction management system, illustrating the interconnection between the decentralized blockchain network, the 3D printing hardware module, the IoT sensor module, and the smart contract module, along with the various stakeholders.

FIG. 2 shows an overview of the blockchain-driven automated 3D printing modular construction framework, illustrating the sequential phases of the construction lifecycle including the 3D printing design phase, material procurement phase, 3D printing manufacturing phase, logistics and transportation phase, on-site assembly phase, final handover phase, and post-construction phase, along with the blockchain infrastructure components, stakeholder interactions, and smart contract operations.

FIG. 3 shows performance characteristics of the blockchain-based smart contract framework, including (a) latency measurements in seconds plotted against block number, illustrating the time required to add new blocks to the blockchain, and (b) throughput measured in transactions per second (TPS) plotted against block number, demonstrating the blockchain framework's capability to achieve low latency and high throughput.

FIG. 4 shows a method flowchart of the blockchain-driven automated 3D printing modular construction management method, illustrating the sequential steps of deploying the decentralized blockchain network, configuring the network to store immutable records of full-lifecycle data, integrating 3D printers with blockchain nodes to form the 3D printing hardware module, providing the IoT sensor module with computing preprocessing using optimized computational algorithms, and embedding the smart contract module for automated material authentication, supply chain transaction validation, and milestone-based payment triggering.

The foregoing and other objects, features and advantages of the present invention, as well as the invention itself, will be more fully understood from the following description of preferred embodiments, when read together with the accompanying drawings.

### DETAILED DESCRIPTION

The present disclosure relates to the field of construction management systems, and more particularly to a blockchain-driven automated system and method for managing 3D printing modular construction projects, integrating blockchain technology, IoT sensors, and smart contracts to enhance transparency, efficiency, and sustainability across the full lifecycle of modular construction.

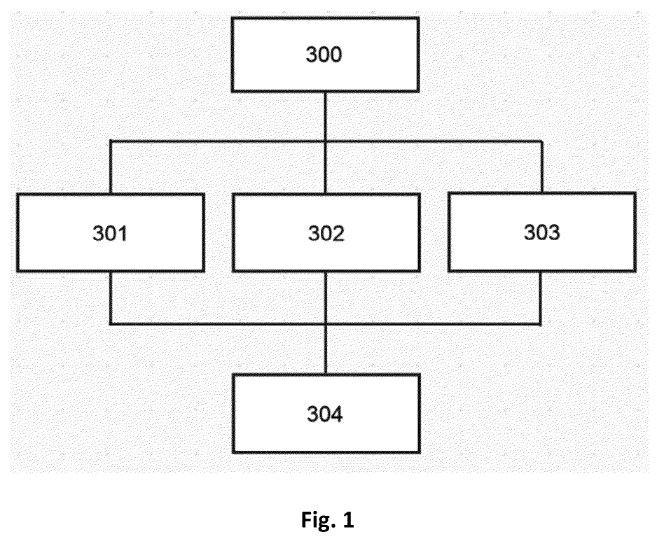

The principles of the present invention and their advantages are best understood by referring to FIG. 1 to FIG. 4. In the following detailed description of illustrative or exemplary embodiments of the disclosure, specific embodiments in which the disclosure may be practiced are described in sufficient detail to enable those skilled in the art to practice the disclosed embodiments. The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

This disclosure outlines a comprehensive framework that leverages blockchain technology and 3D printing to enhance modular construction practices. The invention claims to introduce a new level of transparency, accountability, and efficiency in the construction industry by integrating these advanced technologies across various stages of the modular construction process. In the design phase, the framework enhances transparency and integrity by securely documenting design specifications and changes using blockchain technology. This ensures that all stakeholders have access to immutable records, facilitating smoother approval processes and reducing the likelihood of disputes. During the material procurement phase, the framework utilizes blockchain to automate the tracking and authentication of materials through smart contracts. This ensures a secure and traceable supply chain from suppliers to manufacturers, reducing the risk of fraud and errors while enhancing overall efficiency. In the 3D printing manufacturing phase, the framework provides a detailed, immutable record of all transactions and approvals, streamlining the manufacturing process and reducing administrative overhead. This enhances accountability and ensures compliance with industry standards, making the manufacturing process more efficient and reliable. For the logistics and transportation phase, the framework enables real-time updates and tracking of transportation activities. Smart contracts automate payments upon successful delivery, minimizing delays and reducing payment disputes, which leads to more efficient logistics management. During the on-site assembly phase, the framework documents the assembly process and tracks leftover materials to promote sustainability. By maintaining accurate records of the construction process and automating payments to contractors upon completion, the framework ensures prompt compensation and supports effective resource management. Finally, in the final handover and post-construction phases, the framework maintains a transparent and immutable record of all contractual obligations, approvals, and ongoing maintenance. This enhances trust among stakeholders and supports continued satisfaction by ensuring all necessary approvals are documented and future maintenance needs are well-managed.

The purpose of this invention is to address key challenges in 3D printing-based modular construction by using blockchain to provide a secure, decentralized ledger for recording all transactions, approvals, and interactions. This approach not only improves supply chain management by ensuring the authenticity and quality of 3D-printed components but also mitigates counterfeiting, strengthens intellectual property protection, and supports direct peer-to-peer transactions. By automating various construction phases and enhancing data integrity and transparency, the framework aims to reduce costs, eliminate intermediaries, and promote sustainability through effective resource management and waste reduction. Ultimately, this invention seeks to transform 3D printing-based modular construction into a more resilient, cost-effective, and environmentally friendly practice.

Hereinafter, the invention shall be described according to the embodiments of the invention and by referring to the accompanying description and drawings. However, it is to be understood that limiting the description to the preferred embodiments of the invention and the drawings is merely to facilitate discussion of the present invention and it is envisioned that those skilled in the art may devise various modifications without departing from the scope of the appended claims.

Referring to FIG. 1, the technical structure of the blockchain-driven automated 3D printing modular construction management system 300 is illustrated. The system comprises a decentralized blockchain network 301 deployed on node devices of various stakeholders 305, a 3D printing hardware module 302 integrated with blockchain nodes, an IoT sensor module 303 for real-time data collection and preprocessing, and a smart contract module 304 embedded in the decentralized blockchain network 301 for automated material authentication and milestone-based payment triggering.

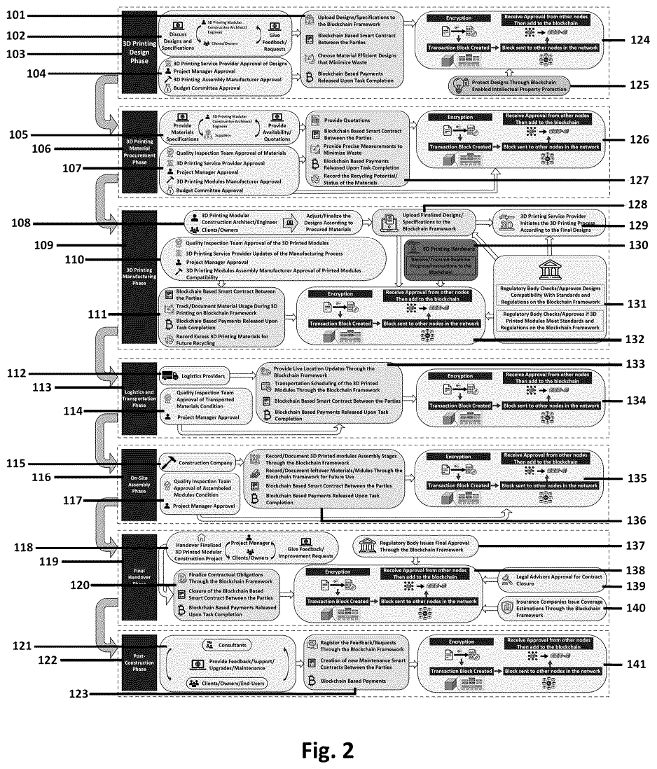

FIG. 2 shows an innovative blockchain-based framework specifically designed for managing 3D printing modular construction projects. This framework integrates cutting-edge blockchain technology 124, 126, 132, 134, 135, 138, 141 with advanced 3D printing techniques 130 and modular construction methods 109, 116 to create a comprehensive, secure, and efficient construction management system. The invention not only enhances transparency and efficiency across the entire supply chain and construction process 101, 127, 111, 133, 130, 136, 120, 123 but also leverages hardware advancements in 3D printing and blockchain infrastructure 130 to optimize performance and sustainability.

In one embodiment, the decentralized blockchain network 301 is deployed on node devices of one or more stakeholders, wherein the one or more stakeholders 305 include one or more of a 3D printing assembly manufacturer 101, a quality inspection team 107, 110, 114, 117, a regulatory body 131, 137, a logistics provider 112, a consultant 121, a budget team 104, 107, and an end-user/client/owner 102, 108, 118, 121, wherein the decentralized blockchain network 301 is configured to store immutable records of full-lifecycle data including design specifications, material procurement, 3D printing production, logistics transportation, on-site assembly, final handover, and post-construction maintenance.

In one embodiment the 3D printing hardware module 302 includes at least one 3D printer 130 integrated with blockchain nodes, wherein the 3D printing hardware module real-time records printing parameters 130, material usage, and quality inspection data to the decentralized blockchain network, and synchronizes digital files, production schedules, and quality control measures with the network.

In one embodiment the IoT sensor module 303 comprises a material parameter sensor, a production progress sensor, and a transportation tracking sensor, wherein the IoT sensor module transmits real-time data to the decentralized blockchain network 301 after a computing preprocessing using optimized computational algorithms, and supports real-time verification of construction processes 101, 127, 111, 133, 130, 136, 120, 123.

In one embodiment the smart contract module 304 is embedded in the decentralized blockchain network 301, wherein the smart contract module 304 includes pre-defined terms for automated material authentication, supply chain transaction validation and milestone-based payment triggering, and links financial transactions directly to project milestones 111.

At the heart of this invention is the integration of blockchain technology with 3D printing 109, forming a robust platform for modular construction. Blockchain technology is utilized to create a decentralized, secure ledger that records all transactions, data exchanges, and construction processes in an immutable format 101, 127, 111, 133, 130, 136, 120, 123. This ledger is critical in ensuring that all stakeholders, including 3D printing assembly manufacturers 101, quality inspection teams 107, 110, 114, 117, regulatory bodies 131, 137, logistics providers 112, consultants 121, budget teams 104, 107, and end-users/clients/owners 102, 108, 118, 121, have access to a transparent, real-time view of the project, enhancing trust and collaboration.

3D printing, a key component of the framework, allows for the precise fabrication of modular components using advanced materials and machinery 109. The hardware involved in 3D printing includes high-precision printers capable of producing complex structures with minimal waste. These printers are integrated with blockchain-based systems that manage the digital files, production schedules, and quality control measures 130.

The blockchain ensures that every aspect of the 3D printing process, from the initial design 103, material procurement 106, 3D printing manufacturing 109, logistics and transportation 113, on-site assembly 116, final handover 119, to post-construction activities 122, is documented and verified, reducing errors and ensuring consistency throughout the entire project lifecycle.

The proposed framework places a significant emphasis on optimizing the supply chain management of 3D printing modular construction projects through the integration of blockchain and 3D printing technologies. Manufacturers employ state-of-the-art 3D printers to produce components and materials 130, leveraging the blockchain to record every step of the production process 109. This integration ensures that each component is traceable, from raw material sourcing 106 to final assembly, enhancing supply chain transparency and efficiency. Suppliers provide raw materials, tools, and machinery, all of which are tracked on the blockchain 106. This tracking is facilitated by hardware sensors and IoT devices integrated into the supply chain, which feed real-time data into the blockchain ledger. Construction companies oversee the assembly of modular units on-site 116, working closely with 3D printing service providers who specialize in creating customized construction components 109. Blockchain developers implement solutions that not only secure transactions and data across the supply chain but also integrate seamlessly with the 3D printing hardware, ensuring that all digital and physical processes are synchronized.

Architects and engineers design modular structures with both blockchain and 3D printing compatibility in mind, ensuring that designs can be efficiently translated into physical components 103. Project managers utilize the blockchain to coordinate between stakeholders, maintain schedules, and manage budgets, with every update being recorded and accessible to all parties involved 104, 107, 110, 114, 117, 118. This real-time, blockchain-based collaboration is crucial in ensuring that the project remains on track and within budget.

The blockchain framework is also pivotal in enhancing the management and security of financial transactions throughout the 3D modular construction process. Smart contracts, which are executed on the blockchain, automate payments and link financial transactions directly to project milestones. This automation is tightly integrated with the hardware aspects of 3D printing, where sensors and monitoring devices report progress to the blockchain, triggering payments once certain conditions are met 101, 127, 111, 133, 136, 120, 123. For example, during the material procurement phase, payments to suppliers are released automatically once materials are authenticated and recorded on the blockchain, with verification done through integrated hardware systems. In the manufacturing phase 109, 3D printing service providers and manufacturers receive payments based on the completion of specific project milestones 111, which are tracked using blockchain-enabled sensors and IoT devices embedded in the 3D printer 130.

Advanced 3D printers, capable of high-precision manufacturing, are integrated with blockchain nodes to ensure that every printing action is recorded and verified. These printers are equipped with sensors that monitor the quality and integrity of the materials used, feeding this data into the blockchain to ensure compliance with project specifications 130. Additionally, the blockchain infrastructure itself relies on secure, distributed hardware networks that ensure data integrity and prevent tampering. Blockchain nodes are strategically placed across the supply chain, from material suppliers 106 to construction sites 109, 116, to maintain a decentralized and secure ledger. These nodes communicate with the 3D printing hardware, ensuring that all data exchanges and transactions are recorded in real time.

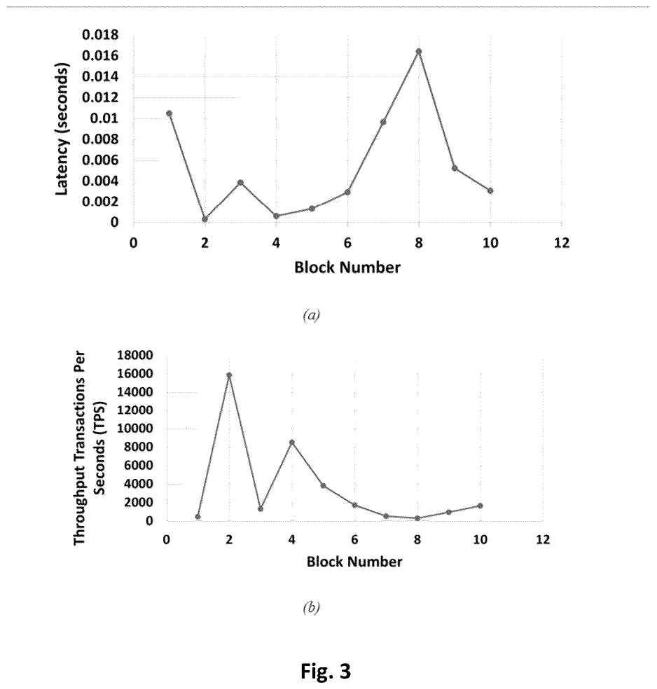

The performance of the proposed blockchain framework invention has been optimized to ensure low latency and high throughput (FIG. 3), which are essential for supporting the fast-paced, high-volume nature of 3D printing modular construction projects. Latency, or the time taken to add a new block to the blockchain, has been minimized through the use of efficient hardware and optimized computational algorithms that quickly validate and add new transactions. This low latency is crucial for maintaining the pace of construction activities, ensuring that data and transaction records are updated almost instantaneously. Throughput, which measures the number of transactions processed per second (TPS), has also been maximized in this blockchain framework. High throughput ensures that the blockchain can handle a large number of transactions in a short period, which is particularly important during peak phases of construction when numerous transactions are occurring simultaneously. The framework achieves this high throughput by using optimized hardware setups and advanced blockchain protocols that allow for rapid transaction processing and block creation.

The invention also plays a significant role in recycling and material waste reduction by leveraging blockchain and 3D printing technologies. The precision of 3D printing minimizes waste by producing components exactly as needed, with every aspect of the production process documented on the blockchain. This documentation includes the types and quantities of materials used 127, 111, 136, which are tracked from procurement 106 to final assembly 116.

The invention also consists of Blockchain-enabled sensors and tracking devices that monitor the use of materials, allowing for efficient recycling and repurposing of leftover materials 130. This data is stored on the blockchain, providing a transparent and immutable record that all stakeholders can access to verify sustainable practices. On the construction site, the modular approach, combined with blockchain-enabled tracking, allows for efficient assembly with minimal waste 116. Any leftover materials or components can be easily identified, cataloged, and either reused or recycled, with every action documented on the blockchain 136.

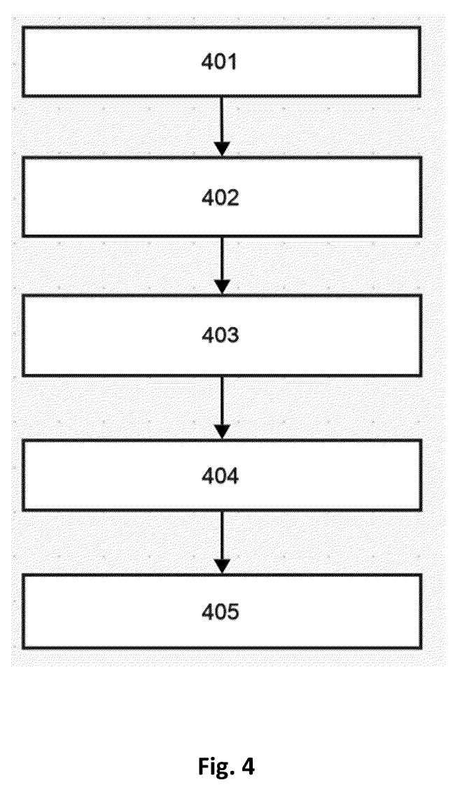

Referring to FIG. 4, the method flowchart of the blockchain-driven automated 3D printing modular construction management method is illustrated. The method comprises deploying 401 a decentralized blockchain network, configuring 402 the network to store immutable records of full-lifecycle data, integrating 403 3D printers with blockchain nodes to form a 3D printing hardware module, providing 404 an IoT sensor module with computing preprocessing, and embedding 405 a smart contract module for automated material authentication and milestone-based payment triggering.

Embodiments

Embodiment 1: The invention described in this disclosure is related to a blockchain-based framework for managing 3D printing modular construction projects, integrating blockchain technology with advanced 3D printing techniques and modular construction methods to create a secure, decentralized ledger for recording all transactions, data exchanges, and construction processes in an immutable format 103, 106, 109, 113, 116, 119, 122.

Embodiment 2: The invention described in embodiment 1 further includes a system wherein the blockchain technology is configured to provide real-time access and transparency to all stakeholders, including 3D printing manufacturers 109, 129, suppliers 105, 106, construction companies 115, architects, engineers 102, 105, 108, project managers 104, 107, 110, 114, 117, 118, logistics providers 112, and end-users/clients/owners 102, 108, 118, 121, enhancing trust and collaboration throughout the construction project lifecycle.

Embodiment 3: The invention described in embodiment 1 further comprises 3D printing technology that utilizes high-precision printers and advanced materials, integrated with blockchain-based systems to manage digital files, production schedules, and quality control measures, ensuring that all aspects of the 3D printing process are documented, verified, and compliant with project specifications 130.

Embodiment 4: The invention described in embodiment 1 further includes a supply chain management system optimized for 3D printing modular construction projects, where blockchain technology records every step of the production process from raw material sourcing 106 to final assembly 116, utilizing hardware sensors and IoT devices to feed real-time data into the blockchain ledger 130.

Embodiment 5: The invention described in embodiment 4 further involves blockchain nodes strategically placed across the supply chain to maintain a secure and decentralized ledger, communicating with 3D printing hardware to ensure all data exchanges and transactions are recorded in real time, thereby enhancing supply chain transparency and efficiency.

Embodiment 6: The invention described in embodiment 1 further includes a financial transaction management system using smart contracts executed on the blockchain, automating payments and linking financial transactions directly to project milestones, with payments triggered upon completion of specific conditions as verified through blockchain-enabled sensors and IoT devices 101, 127, 111, 133, 136, 120, 123.

Embodiment 7: The invention described in embodiment 1 further comprises advanced 3D printers integrated with blockchain nodes that ensure every printing action is recorded and verified, with sensors monitoring the quality and integrity of materials used, feeding data into the blockchain to ensure compliance with project specifications and standards 130.

Embodiment 8: The invention described in embodiment 1 further involves optimizing the blockchain framework for low latency and high throughput (FIG. 3), utilizing efficient hardware and computational algorithms to minimize the time taken to add new blocks to the blockchain and maximize the number of transactions processed per second.

Embodiment 9: The invention described in embodiment 1 further includes a recycling and waste reduction system, leveraging blockchain and 3D printing technologies to document and track the types and quantities of materials used, allowing for efficient recycling and repurposing of leftover materials, with all actions recorded on the blockchain 127, 111, 136.

Embodiment 10: The invention described in embodiment 1 further includes an Internet of Things IoT sensor integrated within the 3D printing modular construction process and connected to a blockchain network, which incorporates stakeholders related to the 3D printing modular construction process.

Embodiment 11: The Internet of Things IoT sensor embedded in the 3D printing modular construction process described in embodiment 10 further transmits and receives real-time data to the 3D printing modular construction stakeholders through the blockchain network.

Embodiment 12: The invention described in embodiment 1 further includes a system of blockchain-based smart contracts and payments activated through the completion of 3D printing modular construction milestones for different stakeholders involved in the process.

Embodiment 13: The invention described in embodiment 1 further includes a system of tracking 3D printing modular construction design changes 103, material procurement and quality checking 106, 3D printing modular construction manufacturing and production schedules 109, 3D printed modules logistics and transportation updates 113, on-site 3D printed modules assembly updates 116, final 3D-printing modules handover 119, post-3D printing modular construction activities 122 and overall construction progress in real-time.

Embodiment 14: The invention described in embodiment 1 further includes a system of issuing blockchain based Intellectual Property (IP) protection of the 3D printing modular construction designs 125.

### Advantages

Enhanced Transparency and Trust: The integration of blockchain technology in the 3D printing modular construction framework ensures that all transactions, design changes, and construction processes are recorded in a decentralized, immutable ledger. This transparency provides all stakeholders, including manufacturers, suppliers, construction companies, architects, engineers, project managers, and clients, with real-time access to accurate and reliable data. As a result, trust among parties is significantly enhanced, reducing the likelihood of disputes and fostering better collaboration throughout the construction lifecycle.

Improved Supply Chain Management: By leveraging blockchain technology and IoT devices, the invention optimizes supply chain management by providing precise tracking and traceability of materials and components from procurement to final assembly. Every step of the production process is recorded on the blockchain, ensuring that materials meet required standards and specifications. This real-time visibility into the supply chain improves inventory management, reduces errors, minimizes delays, and enhances overall efficiency.

Automated and Secure Financial Transactions: The use of smart contracts within the blockchain framework automates financial transactions, linking payments directly to project milestones and specific conditions. This automation reduces administrative overhead, ensures timely payments, and minimizes disputes related to financial transactions. The secure and transparent nature of blockchain also ensures that all financial records are tamper-proof, providing a clear audit trail for all stakeholders.

Optimized Construction Processes: The integration of advanced 3D printing technology with blockchain enables precise fabrication of modular components, ensuring high-quality outputs with minimal waste. The blockchain framework synchronizes digital and physical processes, streamlining project management and ensuring that construction activities are aligned with schedules and budgets. This optimization reduces construction time, lowers costs, and enhances project outcomes.

Low Latency and High Throughput: The blockchain framework is designed to achieve low latency and high throughput, ensuring that transactions are processed quickly and efficiently. This is particularly important in the fast-paced environment of modular construction, where timely data processing and transaction recording are vital. The optimized hardware and computational algorithms minimize delays in adding new blocks to the blockchain, supporting high-volume transaction processing during peak construction phases.

Sustainable Practices and Waste Reduction: The precision of 3D printing, combined with blockchain-enabled tracking, supports sustainable construction practices by minimizing material waste. The blockchain records every aspect of material use, enabling efficient recycling and repurposing of leftover materials. This approach not only reduces environmental impact but also supports a circular economy by ensuring that resources are used efficiently and sustainably.

Enhanced Compliance and Quality Assurance: The blockchain framework provides a secure and transparent platform for recording all compliance-related data, including regulatory approvals, safety inspections, and quality assurance checks. This comprehensive documentation ensures that all aspects of the construction process meet legal standards and building codes, reducing the risk of noncompliance and enhancing overall project quality.

Seamless Integration and Scalability: The invention's design allows for seamless integration of blockchain technology with existing 3D printing and construction systems. The decentralized nature of the blockchain and the use of distributed hardware networks ensure that the system is scalable and can accommodate growing project demands and an increasing number of stakeholders without compromising performance or security.

Enhanced Transparency and Traceability: The integration of blockchain technology ensures all transactions and construction processes are securely recorded in an immutable ledger, reducing disputes and increasing trust among stakeholders.

Automated Workflows: Smart contracts automate financial transactions and project milestones, streamlining workflows and reducing administrative overhead.

Sustainable Practices: The precision of 3D printing minimizes material waste, promoting sustainable practices and reducing costs associated with excess materials.

The invention has been successfully demonstrated through the development of a working prototype and experimental data within a simulated Python-based environment that validate the effectiveness and workability of the disclosed blockchain-based framework for 3D printing modular construction projects. These practical implementations provide concrete evidence that the invention can achieve the intended benefits of enhanced transparency, efficiency, and sustainability in the construction industry.

A fully functional prototype of the blockchain-based construction management system was developed to demonstrate the integration of blockchain technology with 3D printing and modular construction methods. The prototype includes:
Blockchain Infrastructure: A private blockchain network was established, consisting of multiple nodes distributed across various stakeholders, including manufacturers, suppliers, construction companies, architects, and project managers. This network was used to simulate the secure, decentralized recording of transactions, data exchanges, and construction processes.

Smart Contracts: Smart contracts were implemented on the blockchain to automate key processes such as financial transactions, material procurement, and project milestone approvals. These contracts were tested for their ability to trigger automated payments and enforce agreements based on pre-defined conditions, ensuring that funds were released only when specific project criteria were met.

Latency and Throughput Testing: The prototype was tested under different conditions to measure latency (the time taken to add a new block to the blockchain) and throughput (the number of transactions processed per second). Results showed that the blockchain framework achieved low latency and high throughput, confirming its ability to support the fast-paced, high-volume nature of 3D printing modular construction projects (FIG. 3).

Supply Chain Management Simulation: A simulated construction project was executed using the blockchain prototype to manage the entire supply chain. This simulation involved multiple stakeholders, including suppliers, manufacturers, logistics providers, and construction companies. The blockchain effectively tracked the flow of materials and components from procurement to final assembly, demonstrating its capability to enhance transparency and efficiency in supply chain management.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents. The disclosures and the description herein are intended to be illustrative and are not in any sense limiting the present disclosure, defined in scope by the following claims.

Many changes, modifications, variations and other uses and applications of the present disclosure will become apparent to those skilled in the art after considering this specification and the accompanying drawings, which disclose the preferred embodiments thereof. All such changes, modifications, variations and other uses and applications, which do not depart from the spirit and scope of the present disclosure, are deemed to be covered by the invention, which is to be limited only by the claims which follow.

1. A blockchain-driven automated 3D printing modular construction management system, comprising:
a decentralized blockchain network deployed on node devices of one or more stakeholders, wherein the one or more stakeholders include one or more of a 3D printing assembly manufacturer, a quality inspection team, a regulatory body, a logistics provider, a consultant, a budget team, and an end-user/client/owner, wherein the decentralized blockchain network is configured to store immutable records of full-lifecycle data including design specifications, material procurement, 3D printing production, logistics transportation, on-site assembly, final handover, and post-construction maintenance;
a 3D printing hardware module including at least one 3D printer integrated with blockchain nodes, wherein the 3D printing hardware module real-time records printing parameters, material usage, and quality inspection data to the decentralized blockchain network, and synchronizes digital files, production schedules, and quality control measures with the network;
an IoT sensor module comprising a material parameter sensor, a production progress sensor, and a transportation tracking sensor, wherein the IoT sensor module transmits real-time data to the decentralized blockchain network after a computing preprocessing using optimized computational algorithms, and supports real-time verification of construction processes; and
a smart contract module embedded in the decentralized blockchain network, wherein the smart contract module includes pre-defined terms for automated material authentication, supply chain transaction validation, and milestone-based payment triggering, and links financial transactions directly to project milestones.

2. The blockchain-driven automated 3D printing modular construction management system according to claim 1, wherein the decentralized blockchain network is a private blockchain network and implements stakeholder-specific read/write access rights based on their roles in the construction lifecycle, enabling transparent real-time data access for all authorized entities.

3. The blockchain-driven automated 3D printing modular construction management system according to claim 1, wherein the 3D printer in the 3D printing hardware module is a high-precision 3D printer equipped with sensors to monitor material quality and integrity.

4. The blockchain-driven automated 3D printing modular construction management system according to claim 1, wherein the optimized computational algorithms of the IoT sensor module are configured to minimize blockchain latency.

5. The blockchain-driven automated 3D printing modular construction management system according to claim 1, wherein the optimized computational algorithms of the IoT sensor module are configured to maximize blockchain throughput.

6. The blockchain-driven automated 3D printing modular construction management system according to claim 1, wherein the 3D printing hardware module's sensors monitor the quality and integrity of materials used in 3D printing.

7. The blockchain-driven automated 3D printing modular construction management system according to claim 1, wherein the smart contract module's milestone-based payment triggering is verified through blockchain-enabled sensors and IoT devices.

8. The blockchain-driven automated 3D printing modular construction management system according to claim 1, wherein the immutable records stored by the decentralized blockchain network include design changes of the modular construction.

9. The blockchain-driven automated 3D printing modular construction management system according to claim 1, wherein the decentralized blockchain network supports blockchain-based intellectual property protection of 3D printing modular construction designs.

10. A blockchain-driven automated 3D printing modular construction management method, comprising the steps of:
deploying a decentralized blockchain network on node devices of one or more stakeholders, wherein the one or more stakeholders include one or more of a 3D printing assembly manufacturer, a quality inspection team, a regulatory body, a logistics provider, a consultant, a budget team, and an end-user/client/owner;
configuring the decentralized blockchain network to store immutable records of full-lifecycle data including design specifications, material procurement, 3D printing production, logistics transportation, on-site assembly, final handover, and post-construction maintenance;
integrating at least one 3D printer with blockchain nodes to form a 3D printing hardware module, wherein the 3D printing hardware module real-time records printing parameters, material usage, and quality inspection data to the decentralized blockchain network, and synchronizes digital files, production schedules, and quality control measures with the network;
providing an IoT sensor module comprising a material parameter sensor, a production progress sensor, and a transportation tracking sensor, wherein the IoT sensor module performs computing preprocessing on real-time collected data using optimized computational algorithms and transmits the processed data to the decentralized blockchain network to support real-time verification of construction processes; and
embedding a smart contract module in the decentralized blockchain network, wherein the smart contract module executes pre-defined terms for automated material authentication, supply chain transaction validation and milestone-based payment triggering, and links financial transactions directly to project milestones.

11. The method according to claim 10, wherein the decentralized blockchain network is a private blockchain network, and the method further comprises implementing stakeholder-specific read/write access rights based on the stakeholders'roles in the construction lifecycle to enable transparent real-time data access for all authorized entities.

12. The method according to claim 10, wherein the 3D printer in the 3D printing hardware module is a high-precision 3D printer, and the method comprises using the high-precision 3D printer to fabricate modular components while recording printing-related data to the decentralized blockchain network.

13. The method according to claim 10, wherein the optimized computational algorithms of the IoT sensor module are configured to minimize blockchain latency, and the method comprises processing the real-time collected data via the algorithms to reduce the time taken to add data blocks to the blockchain.

14. The method according to claim 10, wherein the optimized computational algorithms of the IoT sensor module are configured to maximize blockchain throughput, and the method comprises processing the real-time collected data via the algorithms to increase the number of transactions processed per second by the blockchain.

15. The method according to claim 10, further comprising using sensors of the 3D printing hardware module to monitor the quality and integrity of materials used in 3D printing, and recording the monitored data to the decentralized blockchain network for compliance verification.

16. The method according to claim 10, wherein the milestone-based payment triggering of the smart contract module is verified through blockchain-enabled sensors and IoT devices, and the method comprises using the sensors and devices to confirm the completion of project milestones and triggering corresponding payments via the smart contract module.

17. The method according to claim 10, further comprising recording design changes of the modular construction in the immutable records stored by the decentralized blockchain network.

18. The method according to claim 10, further comprising utilizing the decentralized blockchain network to implement blockchain-based intellectual property protection of 3D printing modular construction designs by storing design-related immutable records and controlling access to the designs via stakeholder-specific rights.
